(19) United States
(12) Patent Application Publication
(10) Pub. No.: US 2016/0258110 A1
(43) Pub. Date: Sep. 8, 2016

(54) METHOD OF MAKING CONDUCTIVE COTTON USING ORGANIC CONDUCTIVE POLYMER

(71) Applicant: Umm AI-Qura University, Makkah (SA)

(72) Inventor: Fahad Abdullah Alhashmi ALAMER, Mecca (SA)

(73) Assignee: Umm AI-Qura University, Makkah (SA)

(21) Appl. No.: 14/638,793

(22) Filed: Mar. 4, 2015

(51) Int. Cl. D06M 15/63; H01B 1/20; D06P 5/00

(52) U.S. Cl. CPC D06M 15/63; D06P 5/001; H01B 1/20; D06M 2101/04

(57) ABSTRACT

A method of making an electrically conductive cotton material by incorporating conductive poly(3,4-ethylenedioxythiophene) polystyrene sulfonate (PEDOT:PSS) films into a base cotton substrate by drop casting or dip coating. Unlike most conventional methods that have typically included the use of templates such as metal oxide, carbon and/or silica nanoparticles, the polymerization of PEDOT:PSS in this method is not template-assisted. The amount of PEDOT:PSS used in the fabrication process controls the conductivity and sheet resistance of the conductive cotton material, and can be varied by the number of repeated drop casting or dip coating cycles.

### BACKGROUND OF THE INVENTION

1. Technical Field

The present invention relates to methods of imparting conductivity to cotton substrates with conductive polymers to prepare electrically conductive cotton fabric, conductive cotton fabric produced by the method, and smart textiles and electro-optic devices comprising the conductive cotton.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Knitted or woven fabrics have traditionally been used to manufacture common household articles such as bed covers, curtains, and clothes. These fabrics are knitted or woven with natural fiber yarn (e.g. silk, cotton, wool) or man-made yarn (e.g. polyester, nylon). Each type of fiber has unique properties and characteristics suited for different purposes of use, for example, heat conservation, absorptivity, stretchability, etc.

As both technology and society evolve to become more sophisticated, novel functions and performance are demanded of fabrics. For example, fabrics that are capable of conducting electric current for various electric appliances to be installed for convenient use or those that perform heating or cooling actions by themselves may have high demand for many consumer and industrial applications.

Electrically conductive textiles or fabrics have been well-known in the art for at least five decades (see U.S. Pat. No. 2,473,183 to Watson, U.S. Pat. No. 2,327,756 to Adamson—each incorporated herein by reference in its entirety). Conventional conductive textiles and fabrics contain metal particles and/or fibers. Metals, which are excellent conductors, can be expensive, heavy, brittle, fragile and have limited availability. Fabric, on the other hand, is made of fibers and yarns that are lightweight, inexpensive and flexible.

Metal strands or other conductive agents are woven into the construction of the fabric or coated upon the fibers to produce conductive fabric that retains the aforementioned desirable characteristics of fabric. Conductive fibers consist of a non-conductive or less conductive substrate, which is then either coated or embedded with electrically conductive elements such as nickel, copper, gold, silver, titanium and carbon. Substrates typically include cotton, polyester and nylon. Despite innovations in metal inclusion within fibers, the feasible applications of such metal-fabrics beyond smart textiles and wearable computer are limited by the fragility and weight of the metal components.

More recently, the discovery of conductive polymers has led to the possibility of designing and manufacturing of conductive fabrics with minimal or without metal altogether. Conductive polymers, or more precisely, intrinsically conducting polymers (ICPs) are organic polymers that conduct electricity. Such compounds may have metallic conductivity or can be semiconductors. The biggest advantage of conductive polymers is their processability, primarily by dispersion.

ICPs, in general, are not thermoplastics and are therefore not thermoformable. However, like insulating polymers, conductive polymers are organic materials. They can offer high electrical conductivity but do not show similar mechanical properties to other commercially available polymers. These electrical properties can be fine-tuned using methods of organic synthesis and by advanced dispersion techniques.

Examples of ICPs that have been used in the making of fabrics of high conductivity include polyaniline (see U.S. Patent Application Publication 20140138315A1, Chinese Patents CN101403189B to Li et al., CN202187220U to Zhou; Patil, A. J. and Deogaonkar, S. C., (2012) “A Novel Method of in Situ Polymerization of Polyaniline for Synthesis of Electrically Conductive Cotton Fabrics,” Textile Research Journal, 82:1517-30—each incorporated herein by reference in its entirety), polypyrrole (see Patil, A. J. and Deogaonkar, S. C., (2012), “Conductivity and atmospheric aging studies of polypyrrole-coated cotton fabrics,” Journal of Applied Polymer Science, 125(2):844-51—each incorporated herein by reference in its entirety), polyethylene (see U.K. Patent Application GB2424121A—incorporated herein by reference in its entirety), polyacetylene (Shirakawa, H., Louis, E. J., MacDiarmid, A. G., Chiang, C. K., and Heeger, A. J., (1977) “Synthesis of electrically conducting organic polymers: Halogen derivative of polyacetylene, (CH)ₓ” Journal of the Chemical Society, Chemical Communications 16:578-80. —incorporated herein by reference in its entirety), polyfuran, polythiophene, poly(3-alkylthiophene), polyphenylene sulfide, polyphenylenevinylene, polythienylenevinylene, polyphenylene, polyisothianaphthene, polyazulene, poly-2,6-pyridine, polythiophene, poly(terphenylene-vinylene), etc. The more popular ICPs are polyaniline or PANT and polypyrrole due to their relative ease of processability, solubility in its base form and the environmental stability of the conducting state.

ICPs can be prepared by many methods. Most ICPs are prepared by oxidative coupling of monocyclic precursors that entail dehydrogenation:

nH—[X]—H→H—[X]ₙ—H+2(n−1)H⁺+2(n−1)e⁻

Researchers address the low solubility of most polymers through the formation of nanoparticles and surfactant-stabilized conducting polymer dispersions in water, for example, polyaniline nanofibers and PEDOT:PSS (poly(3,4-ethylenedioxythiophene:polystyrene sulfonate).

A crucial process during the synthesis of ICPs is called “doping”. Doping confers or enhances electrical conductivity to these organic materials. ICPs are conjugated systems wherein electrons are only loosely bound, therefore enabling electron flow. However, since ICPs are covalently bonded, these materials need to be doped for electron flow to occur. Doping is either the addition of electrons with alkali metals (reductive or n-doping) or the removal of electrons with (oxidative or p-doping) from the polymer. Common oxidizing agents in p-doping include halogens bromine and iodine as well as sulfuric acid and arsenic pentafluoride. Once doping has occurred, the electrons in π-bonds (from two p orbitals) are able to move along the macromolecule and an electric current occurs. The conductivity of doped polyacetylene is comparable to that of copper and silver whereas in its original form, polyacetylene is a semiconductor.

Methods of ICP inclusion into fabrics are largely similar to the methods for making metal-fabrics. Fabric fibers are dipped into a solution consisting of at least one type of ICP to coat them with a layer of ICP material. Alternatively, fabric fibers and ICPs can also be interwoven in multiple strands of warps and wefts.

The use of ICPs as conductors replacing metals in conductive fabrics has certainly expanded the applications of conductive fabrics. There is a growing interest for these conductive fabrics in electrotherapy, resistive heating, strain sensors, hnetic interference (EMI) shileding of electronic circuits, stealth technology, antistatic and electrostatic discharge (ESD) coating protection, electrodes, photovoltaic devices, solar cells, organic light-emitting diodes (LEDs). However, ICP-fabrics have few large-scale applications due to manufacturing costs, material inconsistencies (irreproducible dispersions), toxicity, poor solubility in solvents and inability to be processed in direct melt processes.

Therefore, in view of the foregoing, there exists a need for improvement in methods of manufacturing ICP-infused conductive fabrics. Such improvements can be directed at the synthesis processes and techniques of ICPs to lower costs, toxicity and to increase stability, solubility and conductivity. Improvements can also be targeted at the treatment process of fabric with doped ICPs to increase the absorbance of the polymer by the fabric.

### BRIEF SUMMARY OF THE INVENTION

The foregoing paragraphs have been provided by way of general introduction, and are not intended to limit the scope of the following claims. The described embodiments, together with further advantages, will be best understood by reference to the following detailed description taken in conjunction with the accompanying drawings.

According to a first aspect, there is provided a method of fabricating an electrically conductive cotton material. The method comprises (a) infusing a base cotton substrate with an aqueous solution comprising one or more organic compounds and a polar solvent to form an infused cotton substrate, (b) incubating the infused cotton substrate at room temperature for 5-15 min to polymerize the one or more organic compounds to form a plurality of electrically conductive polymer films in the absence of a template and (c) removing water from the infused cotton substrate at 90-110° C. for 1-2 h.

In at least one embodiment, the method further comprises repeating (a) to (c) up to 30 times to increase the concentration of the electrically conductive polymer films in the electrically conductive cotton material produced.

In at least one embodiment, the method further comprises, before (a), preparing the aqueous solution by mixing the polar solvent to an aqueous dispersion comprising the one or more organic compounds and sonicating the aqueous solution for 5-10 min at room temperature.

In at least one embodiment, the infusing in the fabrication method is carried out by at least one technique selected from the group consisting of drop casting, soaking, dip coating, inkjet coating, spin coating, extrusion coating, slot-die coating doctor blading, silk screen printing and gravure printing.

In at least one embodiment, the infusing is carried out by drop casting the aqueous solution onto the base cotton substrate.

In at least one embodiment, the infusing is carried out by dip coating, wherein the base cotton substrate is dipped into the aqueous solution for 3-7 min and then taken out of the aqueous solution.

In at least one embodiment, the electrically conductive polymer films comprise polymers selected from the group consisting of poly(3,4-ethylenedioxythiophene) (PEDOT), poly(3,4-ethylenedioxythiophene):poly(styrenesulfonate) (PEDOT:PSS), poly(3,4-ethylenedioxythiophene)-tetramethyacrylate (PEDOT:TMA), poly(thiophene), poly(pyrrole), poly(aniline), poly(acetylene), poly(p-phenylenevinylene) (PPV), poly(indole), poly(carbazole), poly(azepine), (poly)thieno[3,4-b]thiophene, poly(dithieno[3,4-b:3′,4′-d]thiophene), poly(thieno[3,4-b]furan), derivatives thereof, combinations thereof and copolymers thereof.

In at least one embodiment, the electrically conductive polymer films are PEDOT:PSS films, with a PEDOT:PSS ratio by weight of 1:2 to 1:7.

In at least one embodiment, the polar solvent is a polar, aprotic organic solvent selected from the group consisting of dimethyl sulfoxide, acetone, N,N-dimethyl formamide, acetonitrile, ethyl acetate and tetrahydrofuran.

In at least one embodiment, the polar solvent is dimethyl sulfoxide.

In at least one embodiment, the template is selected from the group consisting of metal oxide nanoparticles, silica nanoparticles; and carbon nanoparticles.

In at least one embodiment, the electrically conductive cotton material is substantially free of metal.

In at least one embodiment, the electrically conductive polymer films are coated on at least one surface of the base cotton substrate.

In at least one embodiment, the electrically conductive polymer films are dispersed between the cotton fibers of the base cotton substrate.

In at least one embodiment, the electrically conductive polymer films constitute 0.1-30.0 wt. % based on the weight of the base cotton substrate.

In at least one embodiment, the electrically conductive cotton material has a sheet resistance of 0.1-70,000Ω/□.

According to a second aspect, there is provided an electrically conductive cotton material produced by the method according to the first aspect of the invention, the cotton material being selected from the group consisting of cotton fiber, cotton yarn and cotton fabric.

According to a third aspect, there is provided an electronic component comprising the electrically conductive cotton material according to the second aspect of the invention, the electronic component being selected from the group consisting of electrode, diode, transistor, integrated circuit, resistor, capacitor, memristor, transducer, sensor, and detector.

According to a fourth aspect, there is provided an electrical device comprising the electrically conductive cotton material according to the second aspect of the invention.

According to a fifth aspect, there is provided a clothing product comprising the electrically conductive cotton material according to the second aspect of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows the chemical structure of poly(3,4-ethylenedioxythiophene) polystyrene sulfonate or PEDOT:PSS.

FIG. 2 is a flowchart illustrating different conductive network cotton fabric fabrication processes.

FIG. 3 is an EDX spectrum of untreated cotton (the original sample) according to one embodiment.

FIG. 4 is an EDX spectrum of treated cotton (cotton with conductive polymer) according to one embodiment.

FIG. 5A is an I-V plot of a conductive cotton containing 0.2139 wt. % PEDOT:PSS.

FIG. 5B is an I-V plot of a conductive cotton containing 0.748 wt. % PEDOT:PSS.

FIG. 5C is an I-V plot of a conductive cotton containing 1.518 wt. % PEDOT:PSS.

FIG. 5D is an I-V plot of a conductive cotton containing 1.785 wt. % PEDOT:PSS.

FIG. 5E is an I-V plot of a conductive cotton containing 2.07 wt. % PEDOT:PSS.

FIG. 5F is an I-V plot of a conductive cotton containing 4.844 wt. % PEDOT:PSS.

FIG. 5G is an I-V plot of a conductive cotton containing 5.05 wt. % PEDOT:PSS.

FIG. 5H is an I-V plot of a conductive cotton containing 7 wt. % PEDOT:PSS.

FIG. 5I is an I-V plot of a conductive cotton containing 16.73 wt. % PEDOT:PSS.

FIG. 5J is an I-V plot of a conductive cotton containing 21.7 wt. % PEDOT:PSS.

FIG. 6 shows conductive cotton sheet resistances at different PEDOT:PSS concentrations.

FIG. 7 shows the concentration percolation threshold for conductive cotton sheet resistances.

FIG. 8A is an SEM image of untreated cotton at 120× magnification.

FIG. 8B is an SEM image of the untreated cotton of FIG. 8A at 350× magnification.

FIG. 8C is an SEM image of the untreated cotton of FIG. 8A at 3508× magnification.

FIG. 8D is an SEM image of the cotton of FIG. 8A treated with 0.239 wt. % PEDOT:PSS at 120× magnification.

FIG. 8E is an SEM image of the cotton of FIG. 8A treated with 0.239 wt. % PEDOT:PSS at 800× magnification.

FIG. 8F is an SEM image of the cotton of FIG. 8A treated with 0.239 wt. % PEDOT:PSS at 3495× magnification.

FIG. 8G is an SEM image of the cotton of FIG. 8A treated with 5.05 wt. % PEDOT:PSS at 120× magnification.

FIG. 8H is an SEM image of the cotton of FIG. 8A treated with 5.05 wt. % PEDOT:PSS at 350× magnification.

FIG. 8I is an SEM image of the cotton of FIG. 8A treated with 5.05 wt. % PEDOT:PSS at 2500× magnification.

FIG. 8J is an SEM image of the cotton of FIG. 8A treated with 16.73 wt. % PEDOT:PSS at 100× magnification.

FIG. 8K is an SEM image of the cotton of FIG. 8A treated with 16.73 wt. % PEDOT:PSS at 350× magnification.

FIG. 8L is an SEM image of the cotton of FIG. 8A treated with 16.73 wt. % PEDOT:PSS at 2492× magnification.

FIG. 8M is an SEM image of the cotton of FIG. 8A treated with 21.7 wt. % PEDOT:PSS at 120× magnification.

FIG. 8N is an SEM image of the cotton of FIG. 8A treated with 21.7 wt. ° A PEDOT:PSS at 350× magnification.

FIG. 8O is an SEM image of the cotton of FIG. 8A treated with 21.7 wt. % PEDOT:PSS at 2508× magnification.

### DETAILED DESCRIPTION OF THE EMBODIMENTS

Referring now to the drawings, wherein like reference numerals designate identical or corresponding parts throughout the several views.

The singular forms “a,” “an,” and “the” include plural referents unless the context clearly dictates otherwise. The endpoints of all ranges directed to the same characteristic or component are independently combinable and inclusive of the recited endpoint.

The present disclosure provides a method of making an electrically conductive cotton material using an intrinsically conductive polymer (ICP) and the electrically conductive cotton produced by the method. The electrically conductive cotton material produced generally contains infused intrinsically conductive polymers (ICPs) in a base cotton substrate such as a cotton fabric or a cotton yarn. The electrically conductive cotton material maintains the flexibility of the original untreated cotton substrate material. Compared to metal-based conductive cotton, the ICP-based conductive cotton material provided herein is lightweight, flexible, cost effective, and does not pose toxicity hazards. The ICP-based conductive cotton material provided herein therefore has a wide variety of applications, most notably in smart textiles and wearable electronics, easily replacing the use of indium tin oxide (ITO) or copper which has limited availability, is brittle, fragile and therefore not suitable for the manufacturing of flexible devices. In addition to smart textiles and wearable electronics, the ICP-based conductive cotton material according to the present disclosure can also be used as an electrode, an electrically conducting wire, an electrochromic display, a component in optionally portable electronic devices and electro-optic devices, thin film batteries, energy storage fuel cells, transparent solar cells, RFID sensors, electric contacts and thermoelectric, as well as an electrostatic discharge (ESD) protection and electromagnetic interference (EMI) shielding applications. Examples of electronic components incorporating the conductive cotton material described herein include but are not limited to diodes, transistors, intergrated circuits, resistors, capacitors, memristors, transducers, sensors, detectors.

For purposes of the present disclosure, the term “base cotton substrate” refers to flexible cotton materials such as cotton fiber, cotton yarn and cotton fabric or textiles that are composed of a network of woven or non-woven cotton fibers. Woven cotton materials include woven cotton yarn or cotton fabric formed by weaving, knitting, crocheting, knotting, pressing, braiding, embroidery, ropemaking or the like, multiple fibers together. Non-woven cotton fabric materials may be formed by bonding multiple cotton fibers together via a thermal, mechanical or chemical process. The base cotton substrate in accordance with the present disclosure can be infused with an ICP to produce an electrically conductive cotton material which includes but is not limited an electrically conductive cotton fiber, an electrically conductive cotton yarn and an electrically conductive cotton fabric or textile.

For purposes of the present disclosure, the term “cotton fiber” as used herein includes single filament and multi-filament natural cotton fibers, including cotton yarn. No particular restriction is placed on the length of the cotton fiber, other than practical considerations based on manufacturing considerations and intended use. Similarly, no particular restriction is placed on the width (cross-sectional diameter) of the cotton fibers, other than those based on manufacturing and use considerations. The width of the cotton fiber can be essentially constant, or vary along its length. For many purposes, the cotton fibers can have a largest cross-sectional diameter of 2 nm and larger, for example up to 2 cm, specifically from about 5 nm to about 1 cm. In an embodiment, the cotton fibers can have a largest cross-sectional diameter of about 5 to about 500 μm, preferably about 5 to about 200 μm, more preferably about 5 to about 100 μm, about 10 to about 100 μm, about 20 to about 80 μm, even more preferably about 40 to about 50 μm. In one embodiment, the cotton fiber has a largest circular diameter of about 40 to about 45 micrometers. Further, no restriction is placed on the cross-sectional shape of the cotton fiber. For example, the cotton fiber can have a cross-sectional shape of a circle, ellipse, square, rectangle, or irregular shape.

Exemplary ICPs that can be used to prepare the electrically conductive cotton material include poly(3,4-ethylenedioxythiophene) (“PEDOT”) including poly(3,4-ethylenedioxythiophene):poly(styrenesulfonate) (“PEDOT:PSS”) or poly(3,4-ethylenedioxythiophene)-tetramethyacrylate (PEDOT:TMA) aqueous dispersion, a substituted poly(3,4-ethylenedioxythiophene), a poly(thiophene), a substituted poly(thiophene), a poly(pyrrole), a substituted poly(pyrrole), a poly(aniline), a substituted poly(aniline), a poly(acetylene), a poly(p-phenylenevinylene) (PPV), a poly(indole), a substituted poly(indole), a poly(carbazole), a substituted poly(carbazole), a poly(azepine), a (poly)thieno[3,4-b]thiophene, a substituted poly(thieno[3,4-b]thiophene), a poly(dithieno[3,4-b:3′,4′-d]thiophene), a poly(thieno[3,4-b]furan), a substituted poly(thieno[3,4-b]furan), derivatives thereof, combinations thereof, copolymers thereof and the like. As used herein, the term “polymer” encompasses copolymers that are composed of two or more different monomers or ionomers.

In one embodiment, the ICP used to prepare the electrically conductive cotton material is PEDOT:PSS. PEDOT:PSS is a polymer mixture of two ionomers. One component in this mixture is made up of sodium polystyrene sulfonate which is a sulfonatedpolystyrene. Part of the sulfonyl groups are deprotonated and carry a negative charge. The other component poly(3,4-ethylenedioxythiophene) or PEDOT is a conjugated polymer and carries positive charges and is based onpolythiophene. The PEDOT:PSS weight ratio can range from 1:1 to 1:10, preferably 1:1.5 to 1:8, more preferably 1:2 to 1:7, even more preferably 1:2.5 to 1:6.

The method of preparing ICP-based conductive cotton material in accordance with the present disclosure is advantageous due to its simplicity, speed and formation of stable polymer films in the absence of a template, in particular but not limited to template nanoparticles. A popular method of preparing polymer-based conductive fabric, namely in situ chemical polymerization (oxidative or non-oxidative), has conventionally required the presence of a template such as template nanoparticles for the polymerization step.

As used herein, a template nanoparticle can be any inorganic nano-sized particle (1-100 nm in diameter) that can serve as a polymerization stabilizer and/or site of polymerization during the polymerization process of the ICP. Without wishing to be bound by any particular theory, it is believed that when polymerized in the presence of template nanoparticles as described herein, an ICP can polymerize and form composite nanoparticles including the polymerized ICP material adhered to one or more template nanoparticles. The formed composite nanoparticles can exhibit excellent colloidal stability, as described further below. Inorganic materials for use as a template nanoparticle can include any nano-sized particle having high colloidal stability. By way of example, template nanoparticles can include, without limitation, titanium dioxide (TiO₂), zinc oxide (ZnO), tin(IV) oxide (SnO₂), antimony doped tin(IV) oxide (ASnO₂), silica (SiO₂), carbon (including graphene and graphite) and the like, as well as mixtures of nanoparticles. Template nanoparticles can be formed or provided in any suitable dispersion medium.

Due to the lack of use of a template during the fabrication process, the ICP-infused conductive cotton material provided herein is therefore substantially free of silica, metal and carbon particles. As used herein, “substantially free” refers to a content of silica, metal or non-fibrous carbon (including graphene and graphite) of less than 0.005 wt. % based on the weight of the conductive cotton material, preferably less than 0.002 wt. %, more preferably less than 0.001 wt. %. The lack of metal in the conductive cotton is attributed not only to the lack of use thereof as a polymerization template, but also as a conductor.

The method of fabricating ICP-based conductive cotton material according to the present disclosure utilizes a template-free, solvent-based coating or printing technique which can be chosen from drop casting, soaking, dip coating, inkjet coating, spin coating, extrusion coating, doctor blading, silk screen printing, slot-die coating, gravure printing (or flexo printing), and combinations thereof.

In some embodiments, the fabrication process begins with the addition of a polar solvent is to an ICP solution as a secondary dopant to improve the conductivity to a final concentration of 1-15 wt. % based on the weight of the ICP solution, preferably 2-12 wt. %, more preferably 3-10 wt. %, even more preferably 5-10 wt. %. In at least one embodiment, PEDOT:PSS is used and an PEDOT:PSS aqueous dispersion can be prepared by mixing a 3,4-ethylenedixothiopene or EDOT monomer liquid with an aqueous polystyrene sulfonic acid solution. The PEDOT:PSS aqueous dispersion has a solid content of 0.5-2.5 wt. % based on the weight of the aqueous dispersion, preferably 0.8-2.0 wt. %, more preferably 1.0-2.0 wt. %, and a conductivity of 10°-10¹ S/cm.

The polar solvent may be aprotic or protic, with examples including but not limited to water, ammonia, dimethyl sulfoxide (DMSO), acetonitrile, ethyl acetate, tetrahydrofuran (THF), N,N-dimethyl formamide (DMF), ethylene glycol, propylene glycol monomethyl ether acetate (PGMEA), propylene glycol monomethyl ether (PGME), acetone, methylpyrrolidone, methanol, ethanol, isopropanol, n-butanol, nitromethane, acetic acid, formic acid, 5-hydroxymethyl furanoic acid (HMFA) and combinations thereof. Preferably, a polar aprotic organic solvent is used to dope the ICP, which can be selected from DMSO, acetone, DMF, acetonitrile, ethyl acetate and THF.

The doped ICP solution is sonicated for 3-15 min at room temperature, preferably 4-12 min, more preferably 5-10 min. The sonication can be set in 1 or 2 min-intervals to ensure that the temperature of the doped ICP solution does not increase by more than 5° C., paused to let the solution to cool, then resumed until a homogeneous aqueous dispersion is formed. The doped ICP solution has a conductivity of 10²-10³ S/cm, which is 2-3 orders of magnitude higher than the undoped ICP solution.

After the sonication, the ICP solution is then drop cast onto a base cotton substrate on one or more flat surfaces and left to sit at room temperature for 5-30 min, preferably 5-15 min, more preferably 8-12 min, to allow a spontaneous evaporation the polar solvent, gelling and hardening of the ICP solution due to non-oxidative polymerization and formation of a thin ICP film coating the base cotton substrate. Due to the non-oxidative nature of the polymerization step, the method herein further excludes the use of an oxidant/oxidizer/oxidizing agent. Common oxidants used in chemical polymerization processes include but are not limited to permanganate (sodium permanganate and potassium permanganate), Fenton's reagent which is a mixture of ferrous irons salts and hydrogen peroxide, persulfate, ozone, ferric(III) chloride, ferric(III) p-toluenesulfonate, etc.

In an alternative embodiment, the base cotton substrate can be dipped into the doped and sonicated ICP solution for 1-10 min, preferably 2-8 min, more preferably 3-7 min, even more preferably 4-6 min for coating. After dipping, the coated cotton substrate is taken out and allowed to sit for 5-30 min, preferably 5-15 min, more preferably 8-12 min to dry, and for the polymerization and formation of the thin ICP film coating the base cotton substrate to take place. The base cotton substrate is coated with the ICP solution on one or more flat surfaces.

The ICP-infused cotton sample is then dried at 90-110° C. for at least an hour to fully remove water, preferably 1-3 h, more preferably 1-2 h, even more preferably 1-1.5 h. To increase the concentration of the ICP in the electrically conductive cotton material, the drop casting or dip coating and drying cycles can be repeated for multiple times, for example up to 20 times for a concentration of up to 30 wt. % based on the total weight of the cotton substrate, preferably at least 3 times, more preferably at least 6 times, even more preferably at least 8 times.

In certain embodiments, in addition to the lack of the use of a template (including template nanoparticles) and an oxidant, the fabrication method herein further excludes the use of a binder. As used herein, a binder is an agent that enhances the binding of ICP such as ICP films to the base cotton substrates, which is commonly an organic polymer. Examples of polymeric binders are nitrocellulose, acrylic, polysulfide, polybutadienes (polybutadiene-acrylic-acid or PBAA, polybutadiene-acrylic acid-acrylnitril or PBAN, carboxy-terminated polybutadiene or CTPB, hydroxy-terminated polybutadiene or HTPB), polyurethane, polyglycidyl nitrate (PGN), polyphosphazene, energetic polyoxetanes, glycidyl azide polymer.

The ICP films (not specifically limited to PEDOT:PSS) constitute about 0.1 to about 30.0 wt. % based on the weight of the base cotton substrate (pre-treated and non-conductive), preferably 0.15-25.0 wt. %, more preferably 0.2-22.0 wt. %, even more preferably 0.21-21.7 wt. %, 1.0-21.7 wt. %, 2.0-21.7 wt. % 5.0-21.7 wt. %, 7.0-21.7 wt. %, 10.0-21.7 wt. %, 15.0-21.7 wt. %, 18.0-21.7 wt. % and 20.0-21.7 wt. %.

In general, as the amount of ICP is infused into a base cotton substrate increases, a thicker ICP film and/or an ICP film with a more uniform or even distribution (higher density) is formed. In accordance with the present disclosure, the ICP films have a thickness of 25-1000 nm, preferably 50-800 nm, more preferably 100-750 nm, 150-750 nm, 200-700 nm, 250-650 nm, 250-600 nm, 250-500 nm or 300-500 nm.

Generally, the higher the ICP content is in a conductive cotton material, the lower the resistance (Ω) and sheet resistance (Ω/□) values would be. The conductive cotton material according to the present disclosure has a sheet resistance value of 0.1-100,000Ω/□, preferably 0.1-70,000Ω/□, more preferably 0.1-200Ω/□, 0.1-100Ω/□, 0.1-80Ω/□, even more preferably 0.1-50Ω/□, 0.1-30Ω/□, 0.5-30Ω/□, 0.5-20Ω/□. 1.0-15.0Ω/□, 1.0-10.0Ω/□, 1.5-10.0Ω/□, 1.5-5.0Ω/□ and 1.5-3.0Ω/□.

The pre-treated base cotton substrate can be described as having a smooth surface. A very small amount of the ICP, such as 0.1-0.25 wt. % would suffice to confer conductivity to the cotton substrate, without causing substantial morphological change, as observed using any conventional microscopy technique such as scanning electron microscopy (SEM), transmission electron microscopy (TEM) and scanning transmission electron microscopy (STEM). As the amount of ICP used to infuse the base cotton substrate increases (i.e. from 0.25 wt. % onwards), more morphological and topographical changes to the cotton substrate can observed. In particular, the ICP film formation is found on the surface of the cotton fibers and the spaces between the fibers or bundles of fibers. In some embodiments, the ICP films are present only on the surface of cotton fibers. In some embodiments, the ICPs are present on the surface on all fibers of a cotton yarn. In some embodiments, the ICP films are dispersed between the cotton fibers, which may be single, multifilamental or arranged in bundles. In some embodiments, the ICP films are chemically bonded to the cotton fibers. In some embodiments, the ICP films are coated and adsorbed onto the surface of cotton fibers.

Prior to the ICP infusion, the base cotton substrate may be subjected to standard treatment processes that are known in the textile industry such as scouring with alkali (to lower pectin content in the cotton) and bleaching.

The ICP-infusion method of fabricating an electrically conductive cotton material described herein can be applied to a base cotton substrate of any tensile strength, preferably at least 800 MPa, more preferably at least 1000 MPa, with an elongation at break of 5-10%. The conductive cotton material produced according to the method described herein has a tensile strength of at least 500 MPa, preferably 500-550 MPa, 550-600 MPa, more preferably 600-650 MPa, 650-700 MPa, 700-750 MPa, even more preferably 750-800 MPa, 800-900 MPa and 900-1000 MPa.

The following examples further illustrate methods and protocols of preparing and characterizing a conductive cotton material, and are not intended to limit the scope of the claims.

### Example 1

### Drop-Casting or Dip Coating of PED Titanium Dioxide (TiO₂), Zinc Oxide (ZnO), Tin(IV) Oxide (SnO₂), Antimony Doped Tin(IV) Oxide (ASnO₂), Silica (SiO₂), Carbon 0.1-*OT:PSS on Network Cotton Substrates

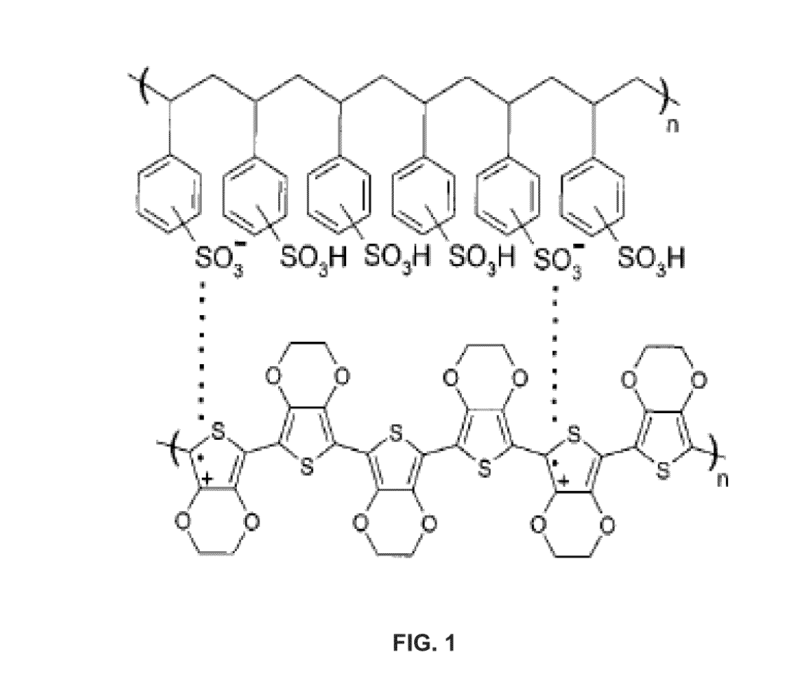

The conductive polymer that was used to prepare the electrical conductive cotton fabric is the commercially available Poly(3,4-ethylenedioxythiophene) Polystyrene sulfonate PEDOT:PSS (Clevios PH 1000) which has the chemical structure as shown in FIG. 1. PEDOT:PSS is known for qualities such as high conductivity, water dispersibility, environmental stability and easy processing. Furthermore, the inclusion of one or more polar organic solvents as a secondary dopant to PEDOT:PSS aqueous dispersion leads to enhanced conductivity.

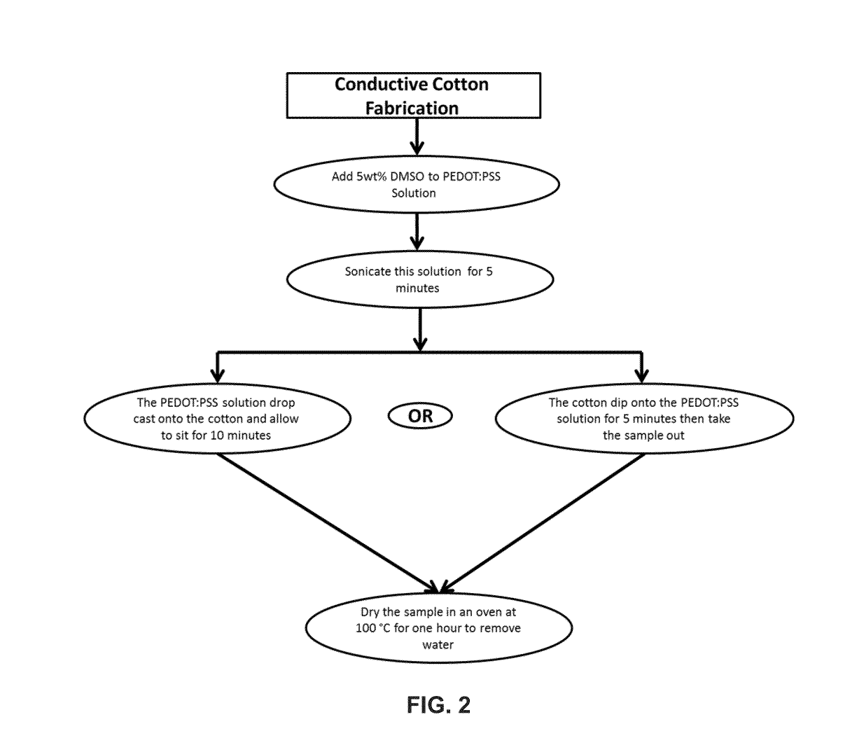

All network cotton samples used had a same area of 1 in² (1 in×1 in). FIG. 2 shows two different processes for fabricating conductive network cotton fabric.

Referring to FIG. 2, a polar solvent, such as dimethyl sulfoxide (DMSO), was added to the PEDOT:PSS solution as a secondary dopant to improve conductivity. The concentration of DMSO is about 5 weight percent (wt. %) based on the total weight of the conductive polymer solution.

The doped PEDOT:PSS solution was sonicated for 5 min. After that, the PEDOT:PSS solution was drop cast onto the network cotton fabric and allowed to sit for 10 min or the cotton was dipped into the PEDOT:PSS solution for 5 min then the sample was removed from the solution and allowed to sit for 10 min.

The sample was dried in an oven at 100° C. for 1 h to remove water. This sample was called treated sample (cotton with conductive polymer).

The concentration of PEDOT:PSS in the network cotton of the treated sample was calculated as the difference in weight between the untreated cotton (the original sample) and the treated sample. The concentration of PEDOT:PSS in the network cotton can be increased by repeating drop casting/drying cycles multiple times. The total amount of the doped conductive polymer infused in the network cotton fabric substrate was from 0.2139 wt. % to about 21.7 wt. % based on the total weight of the network cotton fabric substrates.

### Example 2

### Energy Dispersive X-Ray Analysis of the Synthesized Conductive Cotton Fabric

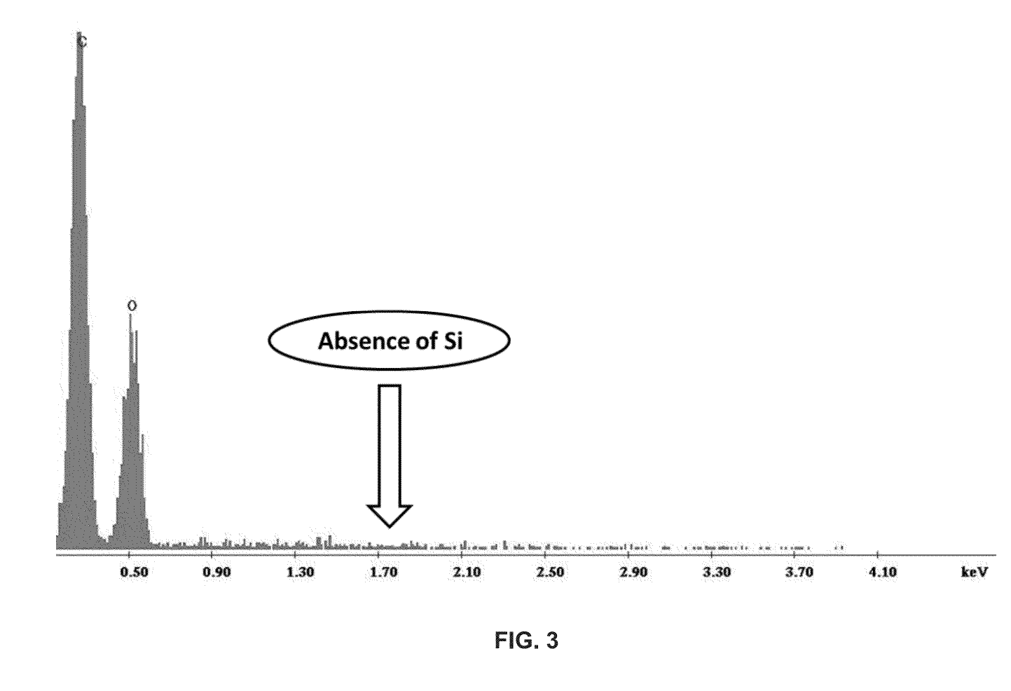

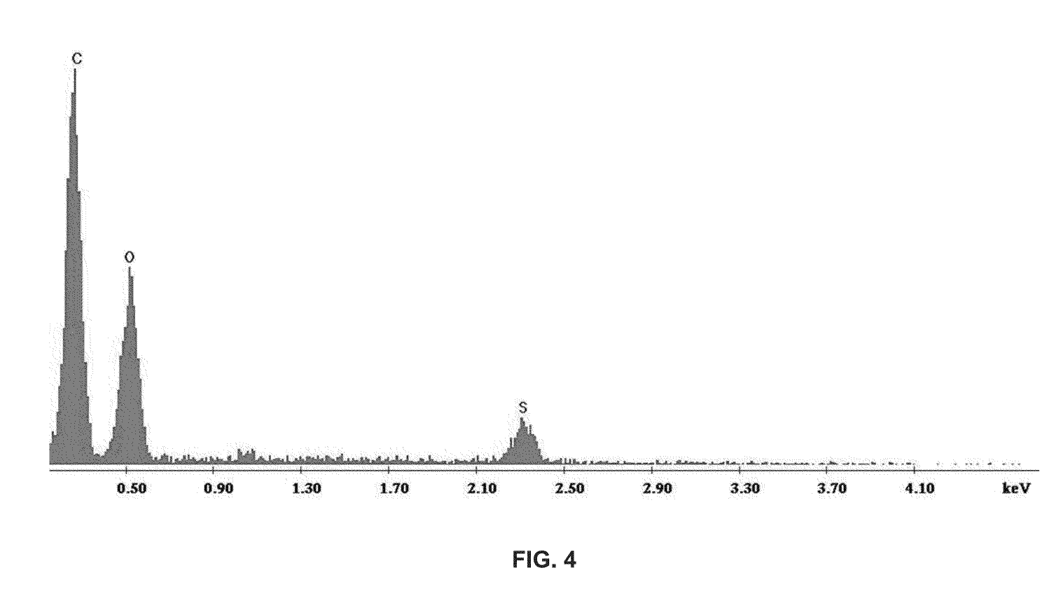

The energy dispersive x-ray spectroscopy (EDX) analysis was carried out using scanning electron microscope (SEM) to identify the elemental composition of the original (untreated) cotton sample and the PEDOT:PSS-treated cotton. FIG. 3 shows the EDX spectrum for untreated cotton which revealed the presence of oxygen (O) and carbon (C) related to the cotton structure and the absence of the silicon escape peak at 1.74 keV. The absence of the peak at 1.74 eV confirmed that the cotton was silica-free. The spectrum of a PEDOT:PSS treated cotton, as shown in FIG. 4, indicates the absence of silica and also the presence of sulfur (S) which is related to the conductive polymer structure.

### Example 3

### Sheet Resistance Studies of the Synthesized Conductive Cotton Fabric

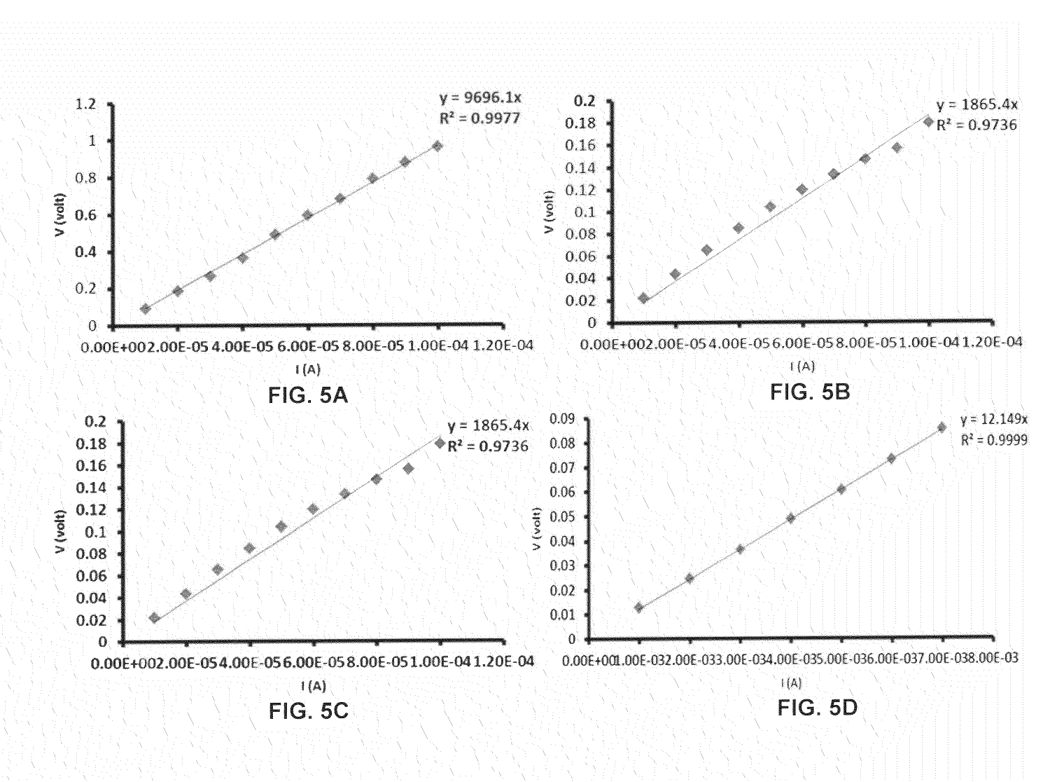

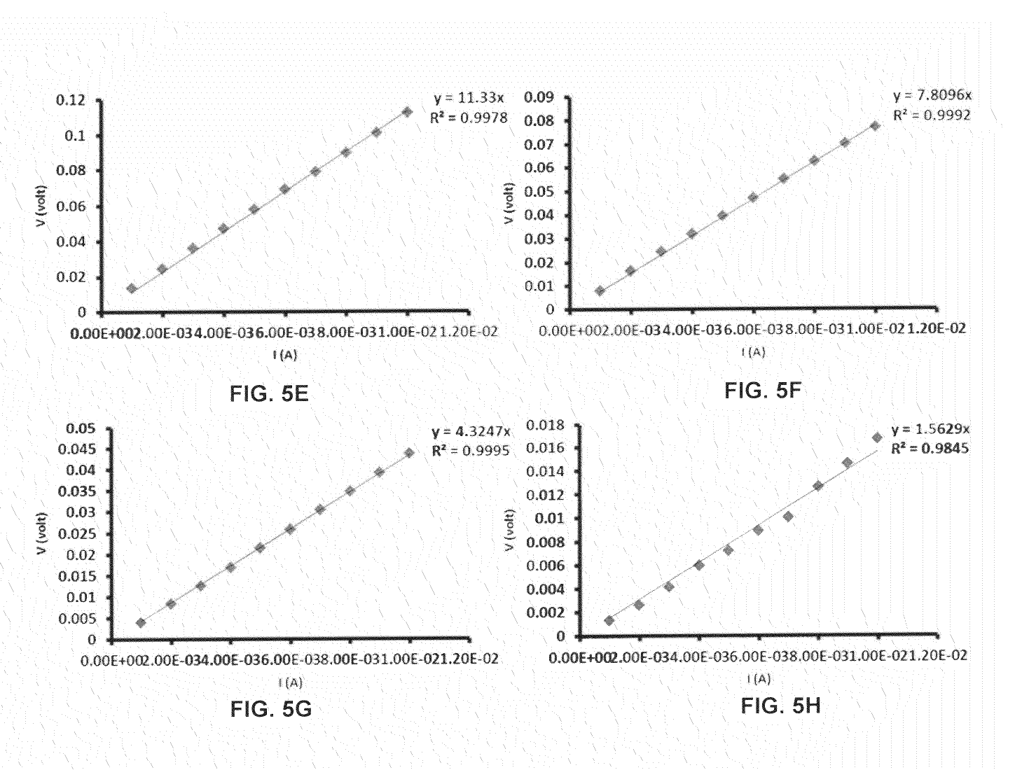

The electrical resistance R of each sample was calculated from the current-voltage curve (I-V), as shown in FIGS. 5A-5J at varying concentrations of PEDOT:PSS which show ohmic behavior. Characterization was carried out using four probe techniques. Then the sheet resistance Rₛ was calculated from the equation Rₛ=R(w/l) where w is width of the sample (w=2.5 cm) and l is the distance between the probe (l=0.35 cm). Table 1 contains the results of resistance and sheet resistance measurements at different concentration of PEDOT:PSS.

TABLE 1
Sheet resistance for conductive network cotton
fabric at various PEDOT:PSS concentrations.

| PEDOT:PSS | | Sheet |
|---|---|---|
| Concentration | Resistance | Resistance |
| (wt. %) | (Ω) | (Ω/□) |
| 0.2139 | 9696.1 | 69060.54 |
| 0.748 | 1865.4 | 13286.32 |
| 1.518 | 20.816 | 148.2621 |
| 1.785 | 12.149 | 86.53134 |
| 2.07 | 11.33 | 80.69801 |
| 4.844 | 7.8096 | 55.62393 |
| 5.05 | 4.3247 | 30.80271 |
| 7 | 1.5629 | 11.13177 |
| 16.73 | 0.3905 | 2.781339 |
| 21.7 | 0.2231 | 1.589031 |

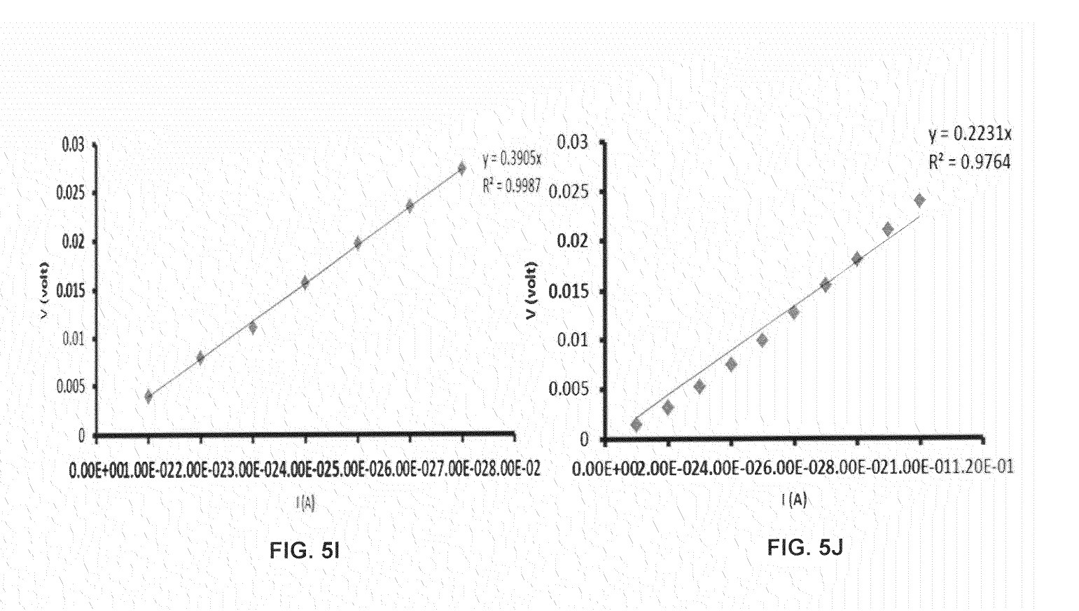

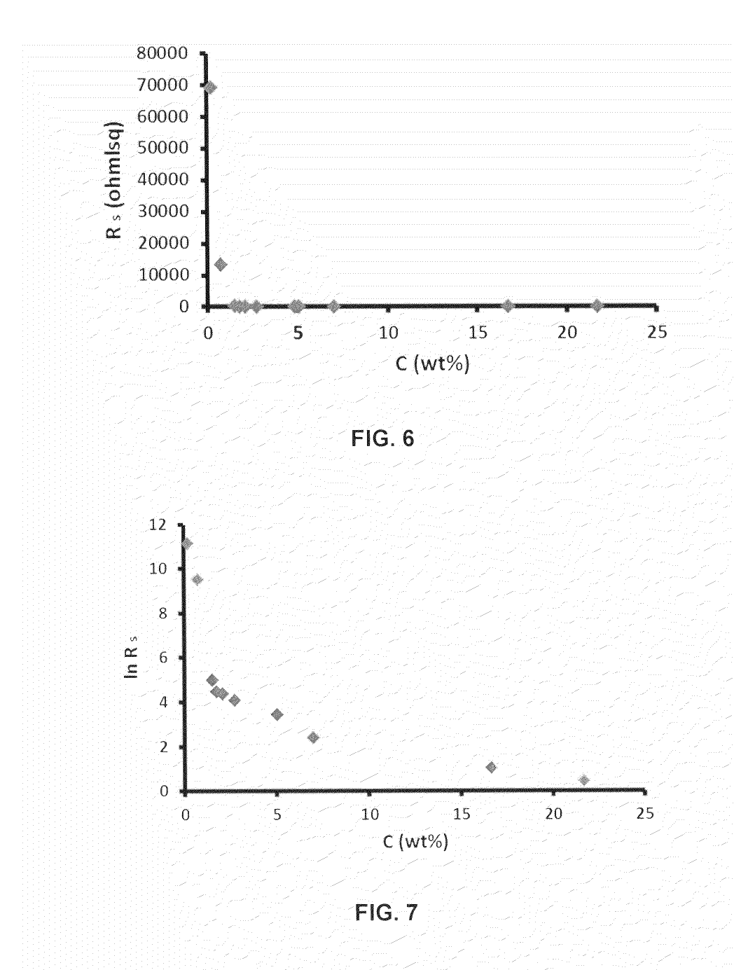

The graphs in FIGS. 6 and 7 show sheet resistance as a function of PEDOT:PSS concentration for different conductive network cotton samples. It can be seen that the sheet resistance of the conductive cotton fabric was decreased with increasing PEDOT:PSS concentration in the sample (a possible reason is provided later herein). At low concentration (0.2139 wt. %) PEDOT:PSS in the network cotton fabric, the sheet resistance was 69.06 kΩ/□ and 1.785 wt. % gave 86.53Ω/□ meaning that sheet resistance decrease by three order of magnitude. Above the 1.785 wt. % concentration, there was no drop in sheet resistance value and therefore this concentration was considered as the percolation threshold for sheet resistance. However, the sheet resistance reached a minimum value of 1.58Ω/□ at the maximum concentration 21.7 wt. %.

### Example 4

### Morphology Studies of the Synthesized Conductive Cotton Fabric

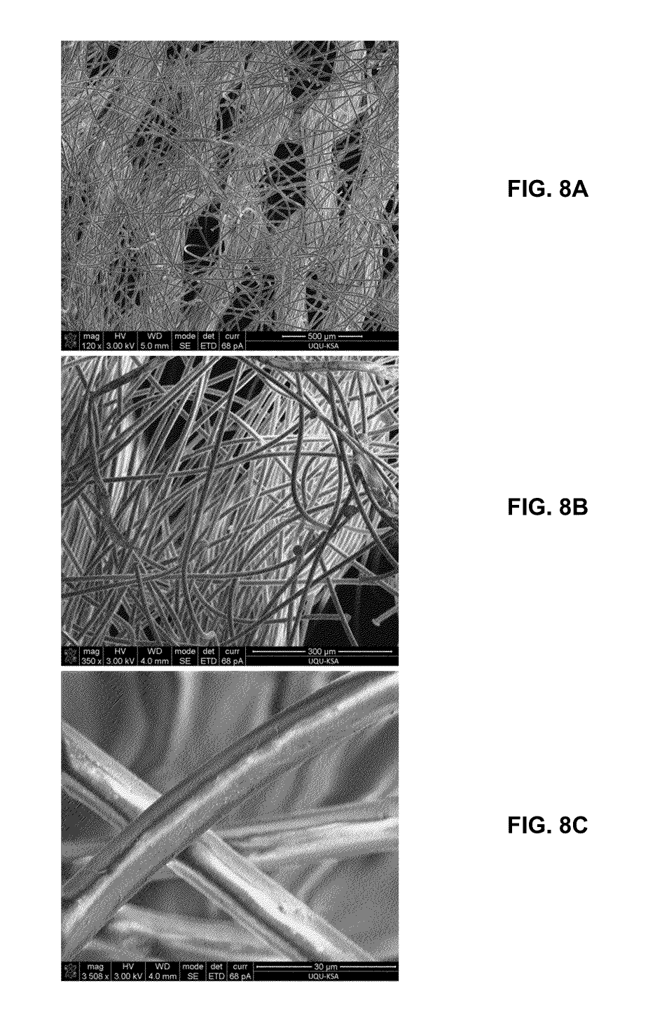

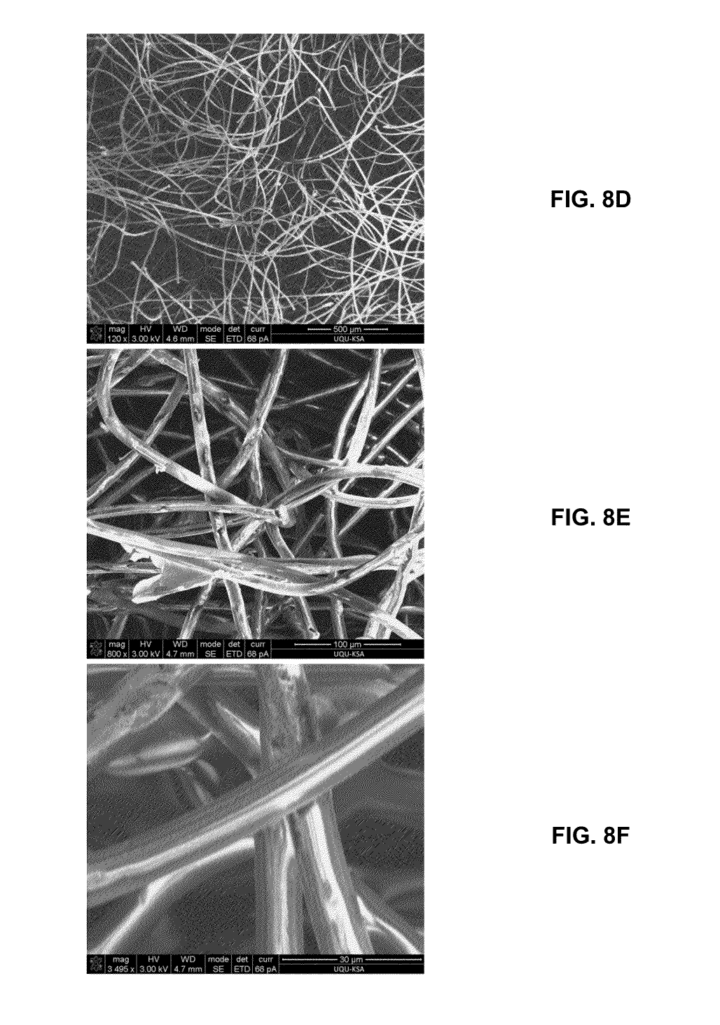

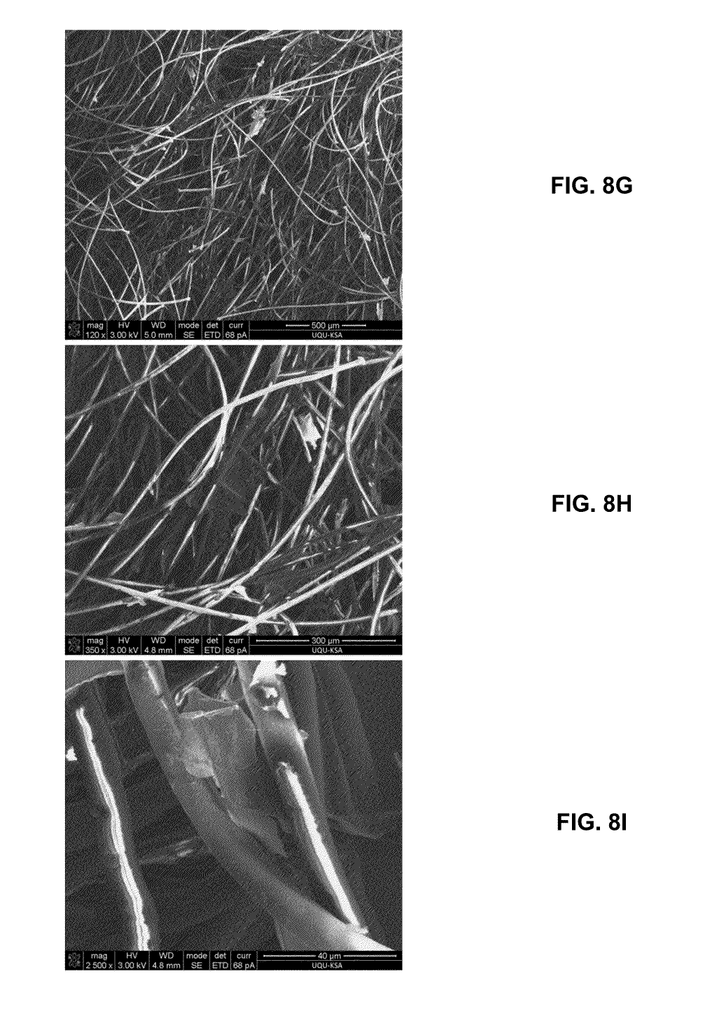

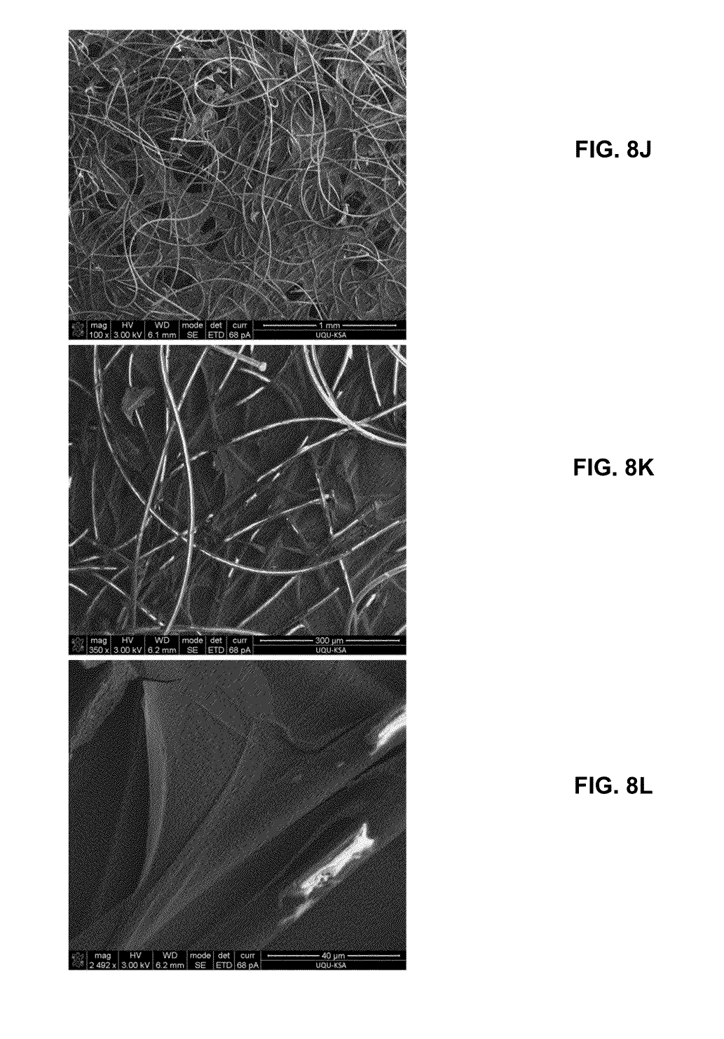

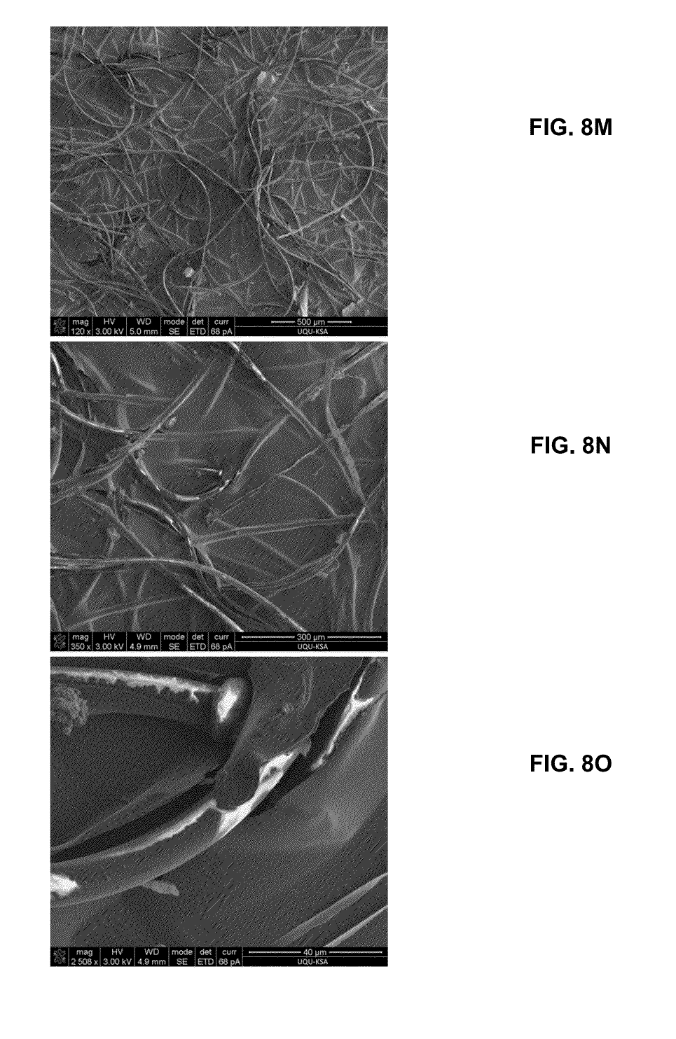

FIGS. 8A-8O are SEM images for the untreated network cotton fabric (FIGS. 8A-8C) and after adding the conductive polymer to the cotton (FIGS. 8D-8O) at different magnifications. FIGS. 8A-8C show the image of SEM of the original sample, i.e. the cotton without undergoing any treatment, at the magnifications 120×, 350× and 3508× respectively. The result of SEM revealed that the cotton fabric comprises both single fibers, groups of fibers arranged in bundles, and the space between the fibers. Also the images show that the cotton fabric was flat with a twisted ribbon-like structure forming the network. Furthermore, the surface of untreated cotton is described as a smooth fiber surface. SEM images of the cotton fibers at different concentrations of PEDOT:PSS from low to high concentrations are shown in FIGS. 8D-8O.

When the network cotton was coated with 0.2139 wt. % PEDOT:PSS, there was no noticeable change in the SEM images (8D-8F) compared to the untreated cotton. However, a film of PEDOT:PSS must be coating the fibers as the cotton changed from being insulating to conductive with a sheet resistance 69.06 kΩ/□.

The SEM images in FIGS. 8G-8O indicated that with the increase of PEDOT:PSS concentrations, more topographical changes occurred at the surface of the fibers and the spaces between the fibers implying the film formation in the fibers and the space between the fibers. The saturation concentration occurred at 7 wt. % at which a film coated the entire surface of the fibers, spaces between the fibers, and space between the bundles as shown in the SEM images of FIGS. 8M-8O. The morphology studies indicate that decreasing sheet resistance occurring with increasing conductive polymer concentration is due to the presence of more conductive polymers coating the fibers, the space between the fibers, and the spaces between the bundles.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of fabricating an electrically conductive cotton material, comprising:
(a) infusing a base cotton substrate with an aqueous solution comprising one or more organic compounds and a polar solvent to form an infused cotton substrate;
(b) incubating the infused cotton substrate at room temperature for 5-15 min to polymerize the one or more organic compounds to form a plurality of electrically conductive polymer films in the absence of a template; and
(c) removing water from the infused cotton substrate at 90-110° C. for 1-2 h.

2. The method of claim 1, further comprising:
(d) repeating (a) to (c) up to 30 times to increase the concentration of the electrically conductive polymer films in the electrically conductive cotton material produced.

3. The method of claim 1, further comprising, before (a):
preparing the aqueous solution by mixing the polar solvent to an aqueous dispersion comprising the one or more organic compounds and sonicating the aqueous solution for 5-10 min at room temperature.

4. The method of claim 1, wherein the infusing is carried out by at least one technique selected from the group consisting of drop casting, soaking, dip coating, inkjet coating, spin coating, extrusion coating, slot-die coating doctor blading, silk screen printing and gravure printing.

5. The method of claim 1, wherein the infusing is carried out by drop casting the aqueous solution onto the base cotton substrate.

6. The method of claim 1, wherein the infusing is carried out by dip coating, wherein the base cotton substrate is dipped into the aqueous solution for 3-7 min and then taken out of the aqueous solution.

7. The method of claim 1, wherein the electrically conductive polymer films comprise polymers selected from the group consisting of poly(3,4-ethylenedioxythiophene) (PEDOT), poly(3,4-ethylenedioxythiophene):poly(styrenesulfonate) (PEDOT:PSS), poly(3,4-ethylenedioxythiophene)-tetramethyacrylate (PEDOT:TMA), poly(thiophene), poly(pyrrole), poly(aniline), poly(acetylene), poly(p-phenylenevinylene) (PPV), poly(indole), poly(carbazole), poly(azepine), (poly)thieno[3,4-b]thiophene, poly(dithieno[3,4-b:3′,4′-d]thiophene), poly(thieno[3,4-b]furan), derivatives thereof, combinations thereof and copolymers thereof.

8. The method of claim 1, wherein the electrically conductive polymer films are PEDOT:PSS films, with a PEDOT:PSS ratio by weight of 1:2 to 1:7.

9. The method of claim 1, wherein the polar solvent is a polar, aprotic organic solvent selected from the group consisting of dimethyl sulfoxide, acetone, N,N-dimethyl formamide, acetonitrile, ethyl acetate and tetrahydrofuran.

10. The method of claim 1, wherein the polar solvent is dimethyl sulfoxide.

11. The method of claim 1, wherein the template is selected from the group consisting of metal oxide nanoparticles, silica nanoparticles; and carbon nanoparticles.

12. The method of claim 1, wherein the electrically conductive cotton material is substantially free of metal.

13. The method of claim 1, wherein the electrically conductive polymer films are coated on at least one surface of the base cotton substrate.

14. The method of claim 1, wherein the electrically conductive polymer films are dispersed between the cotton fibers of the base cotton substrate.

15. The method of claim 1, wherein the electrically conductive polymer films constitute 0.1-30.0 wt. % based on the weight of the base cotton substrate.

16. The method of claim 1, wherein the electrically conductive cotton material has a sheet resistance of 0.1-70,000Ω/□.

17. An electrically conductive cotton material produced by the method of claim 1, the cotton material being selected from the group consisting of cotton fiber, cotton yarn and cotton fabric.

18. An electronic component comprising the electrically conductive cotton material of claim 17, the electronic component being selected from the group consisting of electrode, diode, transistor, integrated circuit, resistor, capacitor, memristor, transducer, sensor, and detector.

19. An electrical device comprising the electrically conductive cotton material of claim 17.

20. A clothing product comprising the electrically conductive cotton material of claim 17.
